(19) United States
(12) Patent Application Publication
(10) Pub. No.: US 2008/0270089 A1
(43) Pub. Date: Oct. 30, 2008

(54) Through-current power table, method of generating thereof and method of calculating power consumption

(75) Inventors: Yushi Okuno, Kanagawa (JP); Takashi Nakaya, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/081,057

(22) Filed: Apr. 10, 2008

(30) Foreign Application Priority Data
Apr. 26, 2007 (JP) 2007-116504

(51) Int. Cl. G06F 17/10; G06F 17/30

(52) U.S. Cl. 703/2; 707/100; 707/E17.01

(57) ABSTRACT

A through-current power table indicates through-current power of a standard cell with respect to each combination of plural kinds of waveform distortion of an input signal input to the standard cell and plural kinds of power supply voltage supplied to the standard cell. A method of calculating power consumption of a circuit comprises: performing a computer simulation of the circuit to calculate waveform distortion of an input signal with respect to each standard cell; calculating through-current power corresponding to the calculated waveform distortion and a specified power supply voltage by reference to the through-current power table; calculating charge-discharge power of the circuit by using load capacitance information of the circuit and the specified power supply voltage; and calculating power consumption of the circuit based on the calculated through-current power and the calculated charge-discharge power.

### BACKGROUND OF THE INVENTION

1. Field of the Invention

The present invention relates to design and verification of a semiconductor integrated circuit. In particular, the present invention relates to a through-current power table, a technique of generating the through-current power table, and a technique of calculating power consumption of a semiconductor integrated circuit by using the through-current power table.

This application is based upon and claims the benefit of priority from Japanese patent application No. 2007-116504, filed on Apr. 26, 2007, the disclosure of which is incorporated herein in its entirely by reference.

2. Description of Related Art

A system for calculating power consumption of a circuit in a semiconductor integrated circuit is known. FIG. 1 is a block diagram schematically showing a configuration of a power consumption calculation system. The power consumption calculation system is provided with a power library characterization unit 101, a database 104 and a power consumption calculation unit 103.

The power library characterization unit 101 performs characterization (characteristic analysis) of power consumption of a circuit. That is, the power library characterization unit 101 performs a circuit simulation (e.g. SPICE simulation) of a standard cell to calculate power consumption of the standard cell by using waveform distortion of an input signal input to the standard cell and load capacitance of the standard cell as keys (parameters). Then, the power library characterization unit 101 associates the calculated power consumption with the keys (waveform distortion and load capacitance) to generate an electric power table 121. The power library characterization unit 101 generates the electric power table 121 with respect to each standard cell. The generated electric power tables 121 are stored in a power consumption library 102 in the database 104.

The power consumption calculation unit 103 includes a waveform distortion calculation unit 111 and an operating power calculation unit 113, and generates an operating power data 129 indicating power consumption of a circuit. First, the waveform distortion calculation unit 111 reads circuit information 123 and interconnection RC information 124 from the database 104. The circuit information 123 indicates a gate-level circuit description of the circuit, and the interconnection RC information 124 (SPEF description) indicates load capacitances of interconnections in the circuit which are extracted based on a layout of the circuit. Based on the circuit information 123 and the interconnection RC information 124, the waveform distortion calculation unit 111 performs an analog simulation to calculate waveform distortion of each input signal in the circuit and generates a waveform distortion data 126. Next, based on the waveform distortion data 126, a load capacitance data 127 and operation rate information 125, the operating power calculation unit 113 calculates power consumption of the circuit to generate the operating power data 129 indicating the calculated power consumption. In calculating the power consumption, the operating power calculation unit 113 refers to (looks up) the above-mentioned electric power table 121 that is a look-up table.

FIG. 2 conceptually shows an example of the electric power table 121. The electric power table 121 associates the waveform distortion and the load capacitance with the calculated power consumption A1 that includes both of charge-discharge power and through-current power. The electric power table 121 is provided with respect to each type of the standard cell. The standard cell is exemplified by functional elements (primitive cells) such as an inverter, an AND circuit and an OR circuit. By reference to the electric power table 121, it is possible to obtain the power consumption A1 corresponding to the waveform distortion indicated by the waveform distortion data 126 and the load capacitance indicated by the load capacitance data 127, with regard to each standard cell in the circuit.

For example, PowerCompiler by Synopsys Inc. is known as a program (software) used in the above-described power consumption calculation system.

Japanese Laid-Open Patent Application JP-H9-026456 discloses a power consumption calculation system. The power consumption calculation system calculates power consumption of a semiconductor integrated circuit. The power consumption calculation system is provided with a time calculation means, a consumption current calculation means and a frequency estimation means. Based on a rise time and a fall time of an input signal to each element included in the integrated circuit, the time calculation means calculates a rise time and a fall time of an input signal to each element of the next stage, respectively. Based on the rise time and the fall time of the input signal to each element, the consumption current calculation means calculates consumption current of each element at a time when an output signal changes. The frequency estimation means estimates frequency of the change in the output signal at each element. The power consumption calculation system calculates the power consumption of the integrated circuit based on the consumption current of each element at the time when the output signal changes and the frequency of the change in the output signal at each element.

The inventors of the present application have recognized the following points.

In recent years, a technique that can vary a power supply voltage to a semiconductor integrated circuit in one chip has been used. However, the table look-up method described in FIG. 1 uses the electric power table 121 shown in FIG. 2 and does not support the case of the variable power supply voltage. Therefore, it is not possible to calculate power consumption of the semiconductor integrated circuit in the case of the variable power supply voltage. In order to support the variable power supply voltage by the conventional table look-up method described in FIG. 1, it is necessary to performs the characterization by using a power supply voltage as the third key (parameter) in addition to the foregoing two keys; the waveform distortion and the load capacitance. In this case, the keys are increased from two parameters to three parameters, which requires much more circuit simulations to be done in the characterization. The increase in the number of executions of the circuit simulation leads directly to increase in TAT (Turn Around Time) of the characterization, which is not preferable. A technique is desired which can support the case of the variable power supply voltage without increasing the characterization TAT.

### SUMMARY

In an aspect of the present invention, a through-current power table with regard to a standard cell is provided. The through-current power table includes: data of plural kinds of waveform distortion of an input signal input to the standard cell; data of plural kinds of power supply voltage supplied to the standard cell; and data of through-current power corresponding to each combination of the plural kinds of waveform distortion and the plural kinds of power supply voltage. Thus, the through-current power table indicates through-current power of the standard cell with respect to each combination of the plural kinds of waveform distortion and the plural kinds of power supply voltage. The through-current power table is provided with respect to each cell type. The through-current power table may be recorded on a computer-readable medium.

In another aspect of the present invention, a method of generating the above-mentioned through-current power table is provided. The method includes: (a) performing a computer simulation of the standard cell to calculate time variation of through-current in the standard cell corresponding to each combination of plural kinds of waveform distortion of an input signal input to the standard cell and plural kinds of power supply voltage supplied to the standard cell; (b) calculating through-current power of the standard cell by using the calculated time variation of through-current and corresponding one of the plural kinds of power supply voltage; and (c) generating the through-current power table that indicates the calculated through-current power with respect to each combination of the plural kinds of waveform distortion and the plural kinds of power supply voltage. A through-current power table generation program that, when executed, causes a computer to perform the present method may be recorded on a computer-readable medium.

In still another aspect of the present invention, a method of calculating power consumption of a circuit including standard cells is provided. The method includes: (A) performing a computer simulation of the circuit to calculate waveform distortion of an input signal with respect to each of the standard cells; (B) calculating through-current power corresponding to the calculated waveform distortion and a specified power supply voltage with respect to each of the standard cells, by reference to the above-mentioned through-current power table; (C) calculating charge-discharge power of the circuit by using load capacitance information of the circuit and the specified power supply voltage; and (D) calculating power consumption of the circuit based on the calculated through-current power and the calculated charge-discharge power. A power consumption calculation program that, when executed, causes the present method may be recorded on a computer-readable medium.

According to the present invention, as described above, the through-current power and the charge-discharge power are treated separately in calculating the power consumption. In the related technique shown in FIG. 1, on the other hand, the through-current power and the charge-discharge power have been treated collectively. The electric power table 121 shown in FIG. 2 is prepared, because the power consumption has been considered to be greatly and complicatedly affected by the waveform distortion and the load capacitance. However, the inventors of the present application have first found that the through-current is greatly dependent on the waveform distortion while less dependent on the load capacitance. It is therefore possible to calculate the through-current power with high accuracy without using the load capacitance as a key. The present invention is based on this knowledge.

As to the calculation of the through-current power, the through-current power table (look-up table) which associates the waveform distortion and the power supply voltage with the through-current power is utilized. The through-current power corresponding to a specified waveform distortion and a specified power supply voltage can be easily obtained by reference to the through-current power table. Although the through-current power table does not include the load capacitance as a key, the through-current power can be calculated with high accuracy because of the above-mentioned reason. The through-current power table includes the power supply voltage as a key instead of the load capacitance. Therefore, the power supply voltage dependence of the through-current power can be analyzed. In other words, the present invention can support the case of the variable power supply voltage. Moreover, the through-current power table according to the present invention uses only two parameters of the waveform distortion and the power supply voltage as keys, and it is not necessary to perform characterization of the through-current power table by using the load capacitance as an additional key. Therefore, the characterization TAT can be reduced.

As to the calculation of the charge-discharge power, a computational expression instead of a look-up table is utilized. The charge-discharge power of the circuit can be easily calculated by using load capacitance information and the specified power supply voltage. The power supply voltage dependence of the charge-discharge power can be analyzed. Thus, the present invention can support the case of the variable power supply voltage.

As described above, the technique according to the present invention can support the case of the variable power supply voltage without increasing the characterization TAT.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a configuration of a power consumption calculation system;

FIG. 2 conceptually shows an electric power table used in the power consumption calculation system shown in FIG. 1;

FIG. 3 is a block diagram showing a configuration of a power consumption calculation system according to an embodiment of the present invention;

FIG. 4 conceptually shows a through-current power table according to the embodiment of the present invention;

FIG. 5 is a block diagram showing a configuration of a power library characterization unit according to the embodiment of the present invention;

FIG. 6 is a schematic diagram showing an example of a standard cell in the embodiment of the present invention;

FIG. 7 is a schematic diagram for explaining an example of a SPICE simulation in the embodiment of the present invention;

FIG. 8 is a schematic diagram for explaining calculation of waveform distortion in the embodiment of the present invention; and

FIG. 9 is a flow chart showing a method of calculating power consumption of a semiconductor integrated circuit according to the embodiment of the present invention.

### DETAILED DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

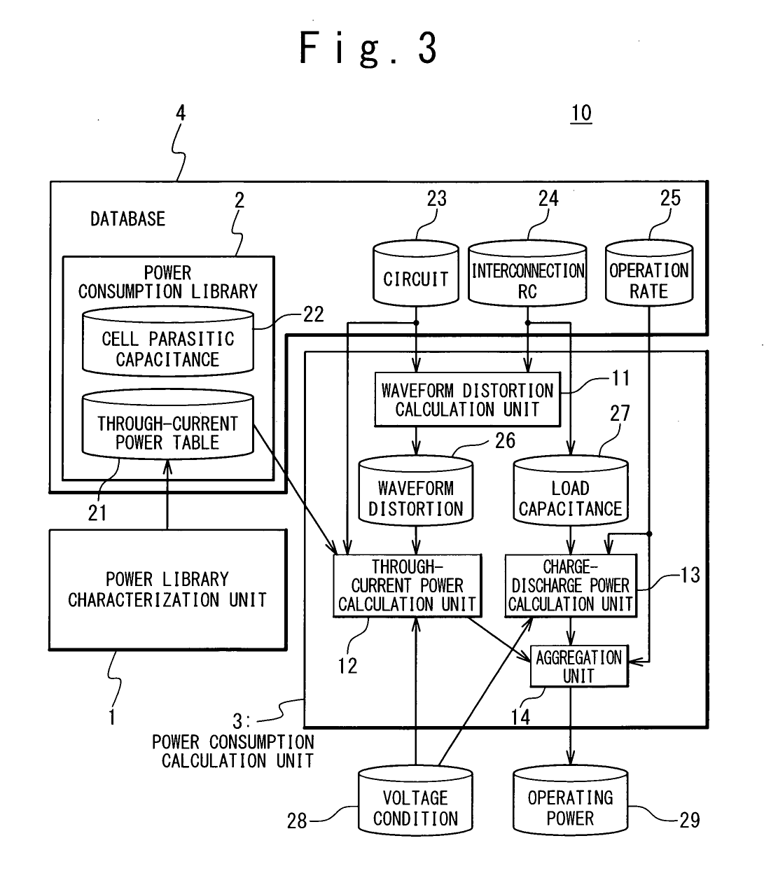

FIG. 3 is a block diagram showing a configuration of a power consumption calculation system 10 according to an embodiment of the present invention. The power consumption calculation system 10 according to the present embodiment is achieved by installing a power consumption calculation program on an information processing equipment such as a personal computer. The power consumption calculation program may be recorded on a computer-readable recording medium. The power consumption calculation system 10 executes the power consumption calculation program to calculate (estimate) power consumption of a semiconductor integrated circuit by reference to a through-current power table 21 which will be described later. As shown in FIG. 3, the power consumption calculation system 10 is provided with a power library characterization unit 1, a database 4 and a power consumption calculation unit 3.

The power library characterization unit 1 performs characterization (characteristic analysis) of power consumption of a circuit. More specifically, the power library characterization unit 1 performs a circuit simulation (e.g. SPICE simulation) of a standard cell to calculate a through-current that flows through constituent elements of the standard cell. Here, the power library characterization unit 1 calculates the through-current by using waveform distortion Trf of an input signal input to the standard cell and a power supply voltage VDD supplied to the standard cell as keys (parameters). Furthermore, the power library characterization unit 1 calculates through-current power due to the through-current. Then, the power library characterization unit 1 associates the calculated through-current power with the keys (waveform distortion and power supply voltage) to generate a through-current power table 21. The power library characterization unit 1 generates the through-current power table 21 with respect to each standard cell type. The generated through-current power tables 21 are stored in a power consumption library 2 in the database 4.

The database 4 includes various data and program which are stored in a memory device such as an HDD (Hard Disk Drive). The database 4 is used for calculating (estimating) power consumption of a semiconductor integrated circuit by the power consumption calculation system 10 (power consumption calculation program). As shown in FIG. 3, the database 4 includes the power consumption library 2, circuit information 23, interconnection RC information 24 and operation rate information 25.

The power consumption library 2 includes a cell parasitic capacitance data 22 and the through-current power table 21. The cell parasitic capacitance data 22 indicates parasitic capacitance in a standard cell, and is prepared with respect to each standard cell type. The standard cell is exemplified by functional elements (primitive cells) such as an inverter, an AND circuit and an OR circuit.

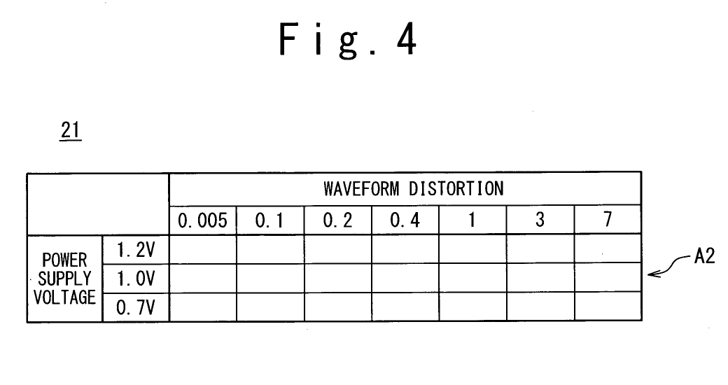

The through-current power table 21 indicates through-current power of a standard cell. The through-current power is a power caused by the through-current flowing through constituent elements of the standard cell, and depends on such keys (parameters) as waveform distortion Trf of an input signal input to the standard cell and a power supply voltage VDD supplied to the standard cell. Thus, the through-current power table 21 associates the through-current power with plural kinds of the waveform distortion Trf and plural kinds of the power supply voltage VDD. FIG. 4 conceptually shows an example of the through-current power table 21 according to the present embodiment. As shown in FIG. 4, the through-current power table 21 includes: data of plural kinds of waveform distortion Trf; data of plural kinds of power supply voltage VDD; and data of through-current power A2 corresponding to each combination of the plural kinds of waveform distortion Trf and the plural kinds of power supply voltage VDD. In other words, the through-current power table 21 indicates the through-current power A2 with respect to each combination of the plural kinds of waveform distortion Trf and the plural kinds of power supply voltage VDD. The through-current power table 21 such as shown in FIG. 4 is provided with respect to each standard cell type. The through-current power table 21 may be recorded on a computer-readable recording medium.

The circuit information 23 indicates a circuit design of a semiconductor integrated circuit (semiconductor chip) that is a design object. The design circuit includes a plurality of standard cells, and the circuit information 23 includes a gate-level netlist (gate-level circuit description) that indicates a connection relationship between the standard cells. The interconnection RC information 24 indicates resistance (R) and load capacitance (C) of each net (interconnection) connecting between standard cells included in the design circuit. The interconnection RC can be extracted from a layout data of the design circuit. The operation rate information 25 indicates an operation rate of each node, i.e. how much each node operates. For example, the operation rate is expressed by a frequency f (=the number of toggling times/a simulation time).

The power consumption calculation unit 3 calculates power consumption of the design circuit by reference to the above-mentioned information (data) in the database 4. Here, the power consumption includes the through-current power and a charge-discharge power of the design circuit. The power consumption calculation unit 3 generates an operation power data 29 that indicates the calculated power consumption (through-current power+charge-discharge power). As shown in FIG. 3, the power consumption calculation unit 3 is provided with a waveform distortion calculation unit 11, a through-current power calculation unit 12, a charge-discharge power calculation unit 13 and an aggregation unit 14.

The waveform distortion calculation unit 11 reads the circuit information 23 and the interconnection RC information 24 (SPEF description) from the database 4. Based on the circuit information 23 and the interconnection RC information 24, the waveform distortion calculation unit 11 performs a computer simulation (analog simulation) of the design circuit to calculate waveform distortion of an input signal with respect to each of the standard cells. Thus, the waveform distortion calculation unit 11 generates a waveform distortion data 26 indicating the calculated waveform distortion with respect to each net (interconnection) connected to each standard cell.

The through-current power calculation unit 12 reads the circuit information 23 from the database 4 and obtains the above-mentioned waveform distortion data 26 and a voltage condition data 28. The voltage condition data 28 indicates a power supply voltage VDD supplied to the design circuit, which is specified by a user. Based on the circuit information 23, the waveform distortion data 26 and the voltage condition data 28, the through-current power calculation unit 12 calculates the through-current power with respect to each of the standard cells included in the design circuit. According to the present embodiment, the through-current power can be calculated by reference to the above-described through-current power table 21 (look-up table) in the power consumption library 2. More specifically, the through-current power calculation unit 12 can calculate the through-current power of each standard cell corresponding to the calculated waveform distortion Trf indicated by the waveform distortion data 26 and the specified power supply voltage VDD indicated by the voltage condition data 28, by reference to the through-current power table 21 that is provided with respect to each cell type.

The charge-discharge power calculation unit 13 obtains load capacitance information with regard to the design circuit. The load capacitance information includes: the cell parasitic capacitance data 22 indicating the parasitic capacitance in each standard cell that is stored in the power consumption library 2; and a load capacitance data 27 indicating the load capacitance of each net. The load capacitance data 27 can be obtained by simply summing up the load capacitances of interconnections indicated by the interconnection RC information 24 with respect to each net. Moreover, the charge-discharge power calculation unit 13 reads the operation rate information 25 from the database 4 and obtains the above-mentioned voltage condition data 28. By using the load capacitance information (22, 27), the specified power supply voltage VDD indicated by the voltage condition data 28 and the frequency f indicated by the operation rate information 25, the charge-discharge power calculation unit 13 calculates a charge-discharge power of the design circuit.

The aggregation unit 14 receives the calculated through-current power from the through-current power calculation unit 12 and the calculated charge-discharge power from the charge-discharge power calculation unit 13, and reads the operation rate information 25 from the database 4. Based on the calculated through-current power, the calculated charge-discharge power and the frequency f, the aggregation unit 14 calculates power consumption of the design circuit. Thus, the aggregation unit 14 generates the operating power data 29 that indicates the calculated power consumption.

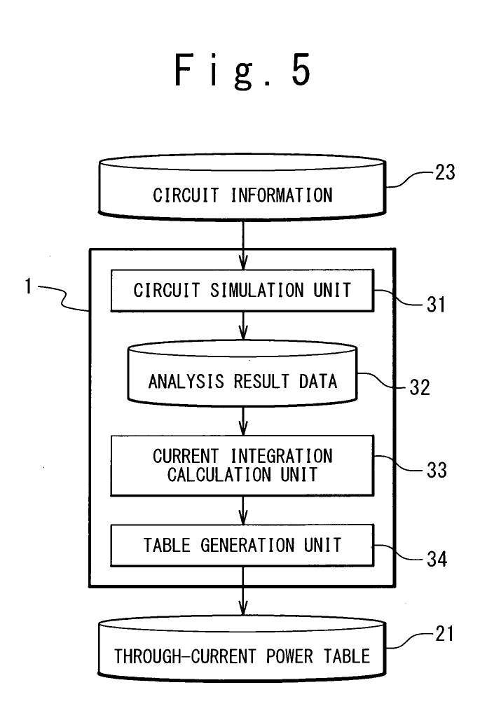

FIG. 5 is a block diagram showing a configuration of the power library characterization unit 1. The power library characterization unit 1 performs the characterization of the through-current power of a standard cell to generate the above-mentioned through-current power table 21 (see FIG. 4) with respect to each standard cell type. As shown in FIG. 5, the power library characterization unit 1 is provided with a circuit simulation unit 31, a current integration calculation unit 33 and a table generation unit 34.

The circuit simulation unit 31 reads the circuit information 23 from the database 4. The circuit simulation unit 31 performs a circuit simulation (e.g. SPICE simulation) of a standard cell indicated by the circuit information 23 to calculate time variation of the through-current that flows through constituent elements of the standard cell. Here, the circuit simulation unit 31 performs the circuit simulation by using the waveform distortion Trf and the power supply voltage VDD as keys (parameters). That is to say, the circuit simulation unit 31 calculates the time variation of the through-current in the standard cell corresponding to each combination of the plural kinds of waveform distortion Trf and the plural kinds of power supply voltage VDD (see FIG. 4). Then, the circuit simulation unit 31 outputs an analysis result data 32 that indicates the result of the circuit simulation, i.e., the calculated time variation of the through-current of the standard cell.

Based on the analysis result data 32, the current integration calculation unit 33 calculates a through-current power of the standard cell corresponding to the calculated through-current. Here, the current integration calculation unit 33 can calculate the through-current power through integration calculation by using the calculated time variation of the through-current and corresponding one of the plural kinds of the power supply voltage VDD. Each calculated through-current power corresponds to each combination of the plural kinds of waveform distortion Trf and the plural kinds of power supply voltage VDD.

The table generation unit 34 associates the calculated through-current power with the keys (waveform distortion Trf and power supply voltage VDD) to generate the through-current power table 21. As shown in FIG. 4, the generated through-current power table 21 indicates the calculated through-current power A2 with respect to each combination of the plural kinds of waveform distortion Trf and the plural kinds of power supply voltage VDD. The table generation unit 34 generates the through-current power table 21 with respect to each standard cell type, and stores the generated through-current power table 21 in the power consumption library 2 in the database 4.

It should be noted that the power library characterization unit 1 according to the present embodiment may be provided as an independent system (through-current power table generation system). The through-current power table generation system can be achieved by installing a through-current power table generation program on an information processing equipment such as a personal computer. The through-current power table generation program may be recorded on a computer-readable recording medium. The through-current power table generation system executes the through-current power table generation program to generate the through-current power table 21 with respect to each cell type. For example, the through-current power table generation system is provided with the circuit simulation unit 31, the current integration calculation unit 33 and the table generation unit 34, as shown in FIG. 5.

According to the present embodiment, as described above, the through-current power and the charge-discharge power are treated separately in calculating the power consumption. More specifically, the through-current power that is difficult to correct by using a computational expression is calculated by the through-current power calculation unit 12 with reference to the through-current power table 21, while the charge-discharge power that can be easily obtained by using a computational expression is calculated by the charge-discharge power calculation unit 13. This feature is based on the inventors' finding that the through-current is greatly dependent on the waveform distortion while less dependent on the load capacitance. It is therefore possible to calculate the through-current power with high accuracy without using the load capacitance as a key.

As to the calculation of the through-current power, the through-current power table 21 (look-up table) which associates the waveform distortion Trf and the power supply voltage VDD with the through-current power is utilized. The through-current power corresponding to a specified waveform distortion Trf and a specified power supply voltage VDD can be easily obtained by reference to the through-current power table 21. Although the through-current power table 21 does not include the load capacitance as a key, the through-current power can be calculated with high accuracy because of the above-mentioned reason. The through-current power table 21 includes the power supply voltage VDD as a key instead of the load capacitance. Therefore, the power supply voltage dependence of the through-current power can be analyzed. In other words, the present embodiment can support the case of the variable power supply voltage. Moreover, the through-current power table 21 according to the present embodiment uses only two parameters of the waveform distortion Trf and the power supply voltage VDD as keys, and it is not necessary to perform characterization of the through-current power table 21 by using the load capacitance as an additional key. Therefore, the characterization TAT can be reduced.

As to the calculation of the charge-discharge power, a computational expression instead of a look-up table is utilized. The charge-discharge power of the circuit can be easily calculated by using load capacitance information and the specified power supply voltage VDD. The power supply voltage dependence of the charge-discharge power can be analyzed. Thus, the present embodiment can support the case of the variable power supply voltage.

As described above, the technique according to the present embodiment can support the case of the variable power supply voltage without increasing the characterization TAT.

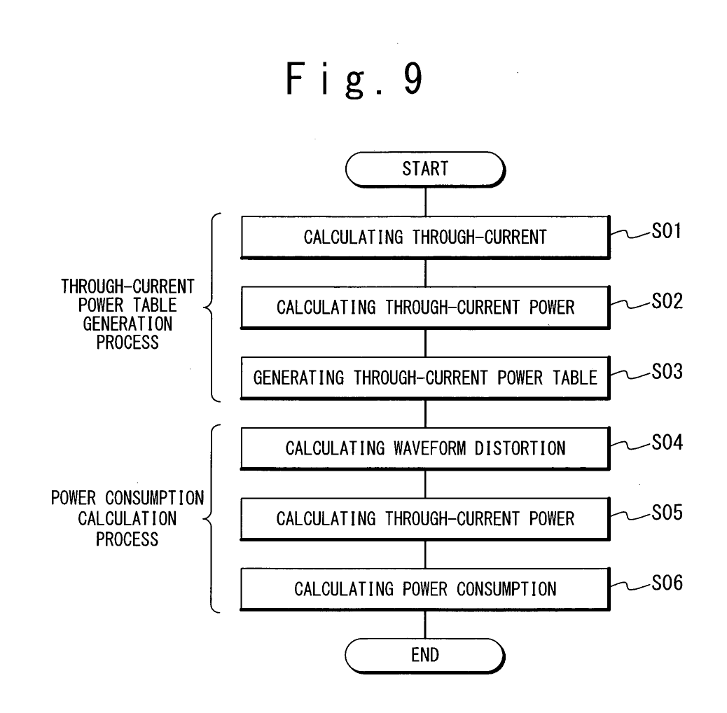

Next, an operation of the power consumption calculation system 10 shown in FIG. 3 and a method of calculating power consumption of a semiconductor integrated circuit according to the present embodiment will be described in more detail. FIG. 9 is a flow chart showing the processing of calculating power consumption of a semiconductor integrated circuit according to the present embodiment. The processing is roughly classified into two processes; the first is a through-current power table generation process (Steps S01 to S03) and the second is a power consumption calculation process (Steps S04 to S06).

First, the through-current power table generation process (Steps S01 to S03) will be described.

Step S01:

In the Step S01, the circuit simulation unit 31 performs a circuit simulation (e.g. SPICE simulation) of a standard cell to calculate time variation of the through-current in the standard cell by using the waveform distortion Trf and the power supply voltage VDD as keys (parameters).

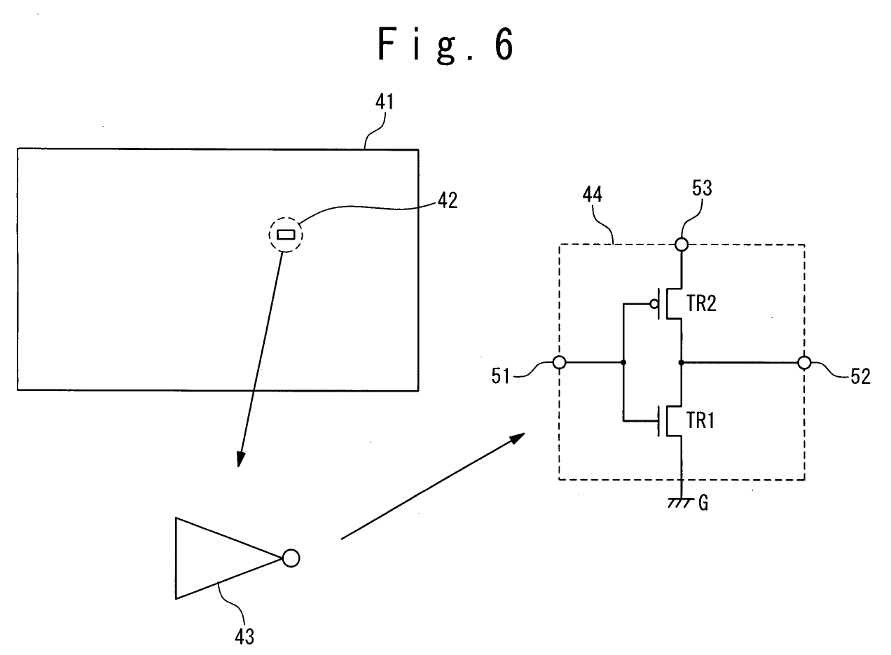

FIG. 6 is a schematic diagram showing a semiconductor integrated circuit (semiconductor chip) as a design circuit and an example of the standard cell included in the design circuit. The semiconductor integrated circuit (semiconductor chip) 41 as the design circuit includes a plurality of standard cells 42 such as an inverter, an AND circuit and an OR circuit. In the present embodiment, the SPICE simulation is performed for each type of the standard cells 42 included in the design circuit 41. In FIG. 6, an inverter 43 (44) is illustrated as an example of the standard cell 42. The inverter 43 is illustrated with a gate-level description, while the inverter 44 is illustrated with a transistor-level description. In the SPICE simulation, the transistor-level description (SPICE format) is used. As shown in FIG. 6, the inverter 44 is provided with an input terminal 51, an output terminal 52, a power supply terminal 53, an N-channel transistor TR1, a P-channel transistor TR2 and a ground terminal G. Moreover, time variations of respective voltages at the input terminal 51, the power supply terminal 53 and the ground terminal G and the load capacitance at the output terminal 52 are given as input parameters to the SPICE simulation.

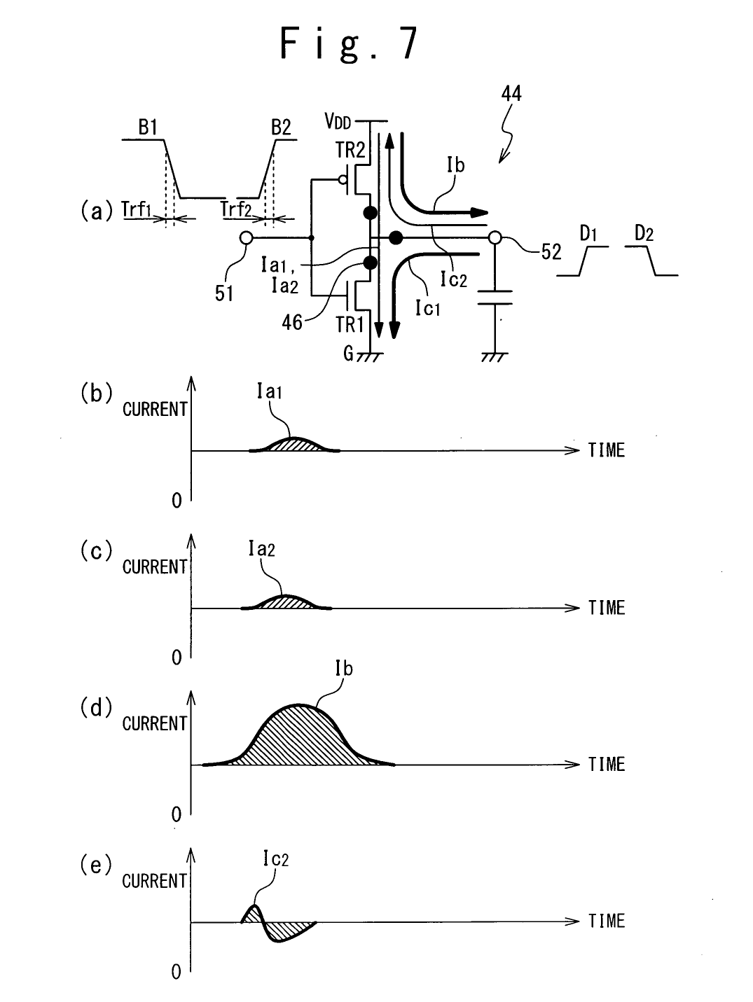

FIG. 7 is a schematic diagram for explaining an example of the SPICE simulation. Here, the SPICE simulation of the inverter 44 shown in FIG. 6 is explained as an example. In FIG. 7, an item (a) shows the configuration of inverter 44, input signals B1 and B2 to the input terminal 51, output signals D1 and D2 from the output terminal 52, through-currents Ia1 and Ia2 flowing in the inverter 44, and currents Ib, Ic1 and Ic2 flowing in the inverter 44. Three observation points 46 are respectively provided at three positions between the transistors TR1 and TR2 and the output terminal 52, for the purpose of observing the through-currents Ia1 and Ia2. Items (b) to (e) shows time variations of the through-current Ia1, the through-current Ia2, the current Ib and the current Ic2, respectively. A longitudinal axis indicates the magnitude of the current, while an abscissa axis indicates the time.

In a case where the input signal B1 with a predetermined waveform distortion Trf1 (voltage change: fall) is input to the input terminal 51, the p-channel transistor TR2 is turned ON while the n-channel transistor TR1 is turned OFF. At this time, the current Ib (see the item (d)) flows through the transistor TR2. The current Ib includes the through-current Ia1 (see the item (b)) that passes through the transistors TR1 and TR2. In response to the input signal B1, the output signal D1 (voltage change: rise) is output from the output terminal 52.

In a case where the input signal B2 with a predetermined waveform distortion Trf2 (voltage change: fall) is input to the input terminal 51, the p-channel transistor TR2 is turned OFF while the n-channel transistor TR1 is turned ON. At this time, the current Ic1 flows through the transistor TR1, and the current Ic2 (see the item (e)) flows through the transistor TR2. The currents Ic1 and Ic2 include the through-current Ia2 (see the item (c)) that passes through the transistors TR1 and TR2. In response to the input signal B2, the output signal D2 (voltage change: fall) is output from the output terminal 52.

In the Step S01, the time variations of the through-currents Ia1 and Ia2 (items (b) and (c)) are obtained by observing currents flowing at the power supply terminal and the three observation points 46 in the SPICE simulation. The calculation is performed with respect to each combination of the plural kinds of the waveform distortion Trf and the plural kinds of the power supply voltage VDD. Moreover, the calculation is performed with respect to each standard cell type. The SPICE analysis result indicating the obtained time variations (waveforms) of the through-currents (Ia1, Ia2) is output as the analysis result data 32.

Step S02:

In the Step S02, the current integration calculation unit 33 calculates a through-current power of the standard cell corresponding to the calculated through-current, based on the analysis result data 32. More specifically, the current integration calculation unit 33 performs time integration of the through-currents (items (b) and (c) in FIG. 7), based on the time variations (waveforms) of the through-currents (Ia1, Ia2) indicated by the analysis result data 32. As a result of the time integration, a total amount of charges flowing through the power supply terminal can be calculated. Then, the current integration calculation unit 33 calculates the through-current power (energy [J=W/Hz]) by multiplying the total amount of charges by corresponding one of the plural kinds of the power supply voltage VDD. Each calculated through-current power corresponds to each combination of the plural kinds of waveform distortion Trf and the plural kinds of power supply voltage VDD.

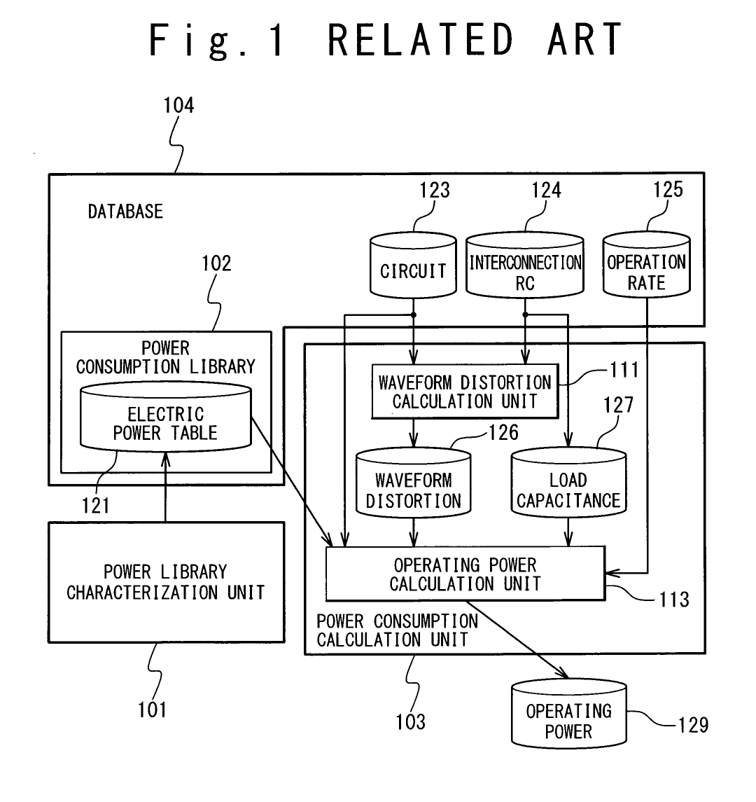

According to the related technique shown in FIG. 1, the time integration of the currents Ib, Ic1 and Ic2 (items (d) and (e) in FIG. 7) that include the through-currents Ia1 and Ia2 is performed. As a result, the calculated power consumption (energy) includes not only the through-current power but also the charge-discharge power. The calculated power consumption is expressed by a form of pin-to-pin (e.g. the input terminal 51 to the output terminal 52) or belonging to a pin. The calculated power consumption (=through-current power+charge-discharge power) is stored in the electric power table 121 in the power consumption library 102.

According to the present embodiment, on the other hand, the time integration of only the through-currents (items (b) and (c) in FIG. 7) is performed as described above. As a result, the through-current power due to the through-currents is calculated. In other words, the power calculated in the present Step S02 does not include the charge-discharge power. The calculated through-current power is expressed by a form of pin-to-pin (e.g. the input terminal 51 to the output terminal 52) or belonging to a pin. The calculated through-current power is stored in the through-current power table 21 in the power consumption library 2. The through-current power table 21 does not include the charge-discharge power.

Step: S03

In the Step S03, the table generation unit 34 associates the calculated through-current power with the keys (waveform distortion Trf and power supply voltage VDD) to generate the through-current power table 21 as shown in FIG. 4. The table generation unit 34 stores the generated through-current power table 21 in the power consumption library 2 in the database 4. By the above-described Steps S01 to S03, the through-current power table generation process is completed. The through-current power table generation process is performed with respect to each standard cell type.

Next, the power consumption calculation process (Steps S04 to S06) will be described.

Step S04:

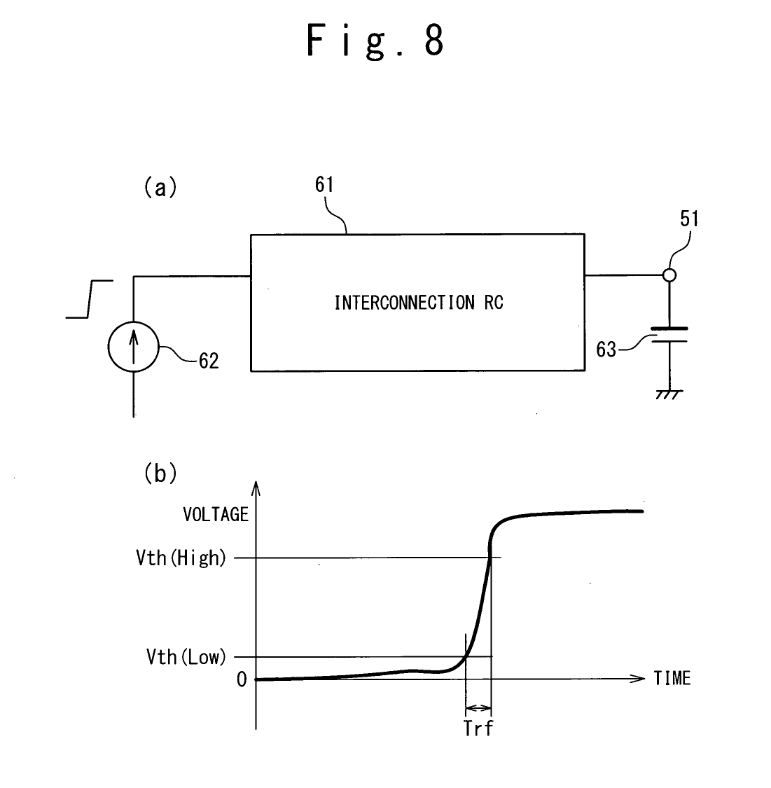

In the Step S04, the waveform distortion calculation unit 11 performs a computer simulation (analog simulation) of the design circuit to calculate the waveform distortion based on the circuit information 23 and the interconnection RC information 24. FIG. 8 is a schematic diagram for explaining the calculation of the waveform distortion. An item (a) in FIG. 8 shows a simple analog simulation circuit used for calculating the waveform distortion. A voltage supplied from a voltage supplying circuit 62 is input to the input terminal 51 of a standard cell (e.g. the inverter 44) through an interconnection (net) 61, to be an input signal of the inverter 44. A capacitance 63 is an input gate capacitance of the inverter 44. At this time, a voltage waveform of the input signal observed at the input terminal 51 is rounded due to the resistance and capacitance of the interconnection (net) 61. An item (b) in FIG. 8 is a graph showing the input signal observed at the input terminal 51, wherein the longitudinal axis indicates the voltage and the abscissa axis indicates the time. The waveform distortion Trf of the input signal is defined by a time difference between the lower threshold voltage (Vth(Low)) and the higher threshold voltage (Vth(High)).

By performing the circuit simulation, it is possible to calculate the waveform distortion Trf of the input signal input to a standard cell that is a constituent element of a circuit indicated by the circuit information 23. The calculation is performed for each interconnection (net) connected to the standard cell, with respect to each of the plurality of standard cells constituting the circuit. The waveform distortion calculation unit 11 generates and outputs the waveform distortion data 26 indicating the calculated waveform distortion with respect to each net (interconnection) connected to each standard cell.

Step S05:

In the Step S05, the through-current power calculation unit 12 calculates the through-current power with respect to each standard cell, based on the circuit information 23, the waveform distortion data 26 and the voltage condition data 28. According to the present embodiment, the through-current power is calculated by reference to the above-described through-current power table 21 (look-up table). More specifically, the through-current power calculation unit 12 calculates the through-current power corresponding to the calculated waveform distortion Trf indicated by the waveform distortion data 26 and the specified power supply voltage VDD indicated by the voltage condition data 28, by reference to the through-current power table 21. It should be noted here that the through-current power table 21 shown in FIG. 4 may not include the precise values of the calculated waveform distortion Trf and the specified power supply voltage VDD. In this case, the through-current power can be calculated using the following equation (1).

$$Table ( VDD , Trf ) = \frac{Trf - Trf 1}{Trf 2 - Trf 1} \times [ \frac{VDD - VDD 1}{VDD 2 - VDD 1} \times \{ ( Table ( VDD 2 , Trf 2 ) - Table ( VDD 1 , Trf 2 ) ) - ( Table ( VDD 2 , Trf 1 ) - Table ( VDD 1 , Trf 1 ) ) \} + ( Table ( VDD 1 , Trf 2 ) - Table ( VDD 1 , Trf 1 ) ] + \frac{VDD - VDD 1}{VDD 2 - VDD 1} \times ( Table ( VDD 2 , Trf 1 ) - Table ( VDD 1 , Trf 1 ) + Table ( VDD 1 , Trf 1 ) \qquad ( 1 )$$

Here, (VDD1, Trf1), (VDD1, Trf2), (VDD2, Trf1) and (VDD2, Trf2) are some combinations of the power supply voltage and the waveform distortion existing in the through-current power table 21. Table(VDD1, Trf1), Table(VDD1, Trf2), Table(VDD2, Trf1) and Table(VDD2, Trf2) represent table values (through-current power) of the through-current power table 21 corresponding to the respective combinations. Even if a combination (VDD, Trf) of the power supply voltage VDD and the waveform distortion Trf does not appear in the through-current power table 21, the through-current power Table(VDD, Trf) corresponding to the combination (VDD, Trf) can be calculated by the above equation (1).

According to the related technique shown in FIG. 1, table values of the electric power table 121, which indicate the power consumption including both of the charge-discharge power and the through-current power, are calculated by using the waveform distortion and the load capacitance as keys. According to the present embodiment, the table values of the through-current power table 21, which indicate the through-current power, are calculated by using the waveform distortion Trf and the power supply voltage VDD as keys.

Step S06:

In the Step S06, the charge-discharge power calculation unit 13 calculates the charge-discharge power by using the cell parasitic capacitance data 22, the load capacitance data 27, the operation rate information 25 and the voltage condition data 28. By using an in-cell parasitic capacitance “C1” indicated by the cell parasitic capacitance data 22, a load capacitance “C2” indicated by the load capacitance data 27, the frequency “f” indicated by the operation rate information 25 and the specified power supply voltage VDD indicated by the voltage condition data 28, the charge-discharge power can be calculated in accordance with the following equation (2).

Charge-discharge power=(C1+C2)×VDD²×f [Equation (2)]

Based on the operation rate information 25, the calculated through-current power and the calculated charge-discharge power, the aggregation unit 14 calculates power consumption of the design circuit to generate the operating power data 29 indicating the calculated power consumption. The power consumption can be calculated in accordance with the following equation (3).

Power consumption={Σ₁Σ₂(through-current power×the number of toggling times)/(simulation time)}+(C1+C2)×VDD²×f [Equation (3)]

Here, the first term of the equation is for the through-current power, and the second term of the equation is for the charge-discharge power. The parameter (the number of toggling times/simulation time) is equal to the frequency f. Σ₂ means that calculation is performed for all combinations of the input terminal and the output terminal with respect to each standard cell in the circuit. Σ₁ means that calculation is performed for all standard cells in the chip. By the above-described Steps S04 to S06, the power consumption calculation process is completed.

As described above, the power consumption calculation system (the power consumption calculation method and program) according to the present embodiment is achieved. The program and data structure used in the present embodiment may be recorded on a computer-readable medium and read by the information processing equipment from the medium.

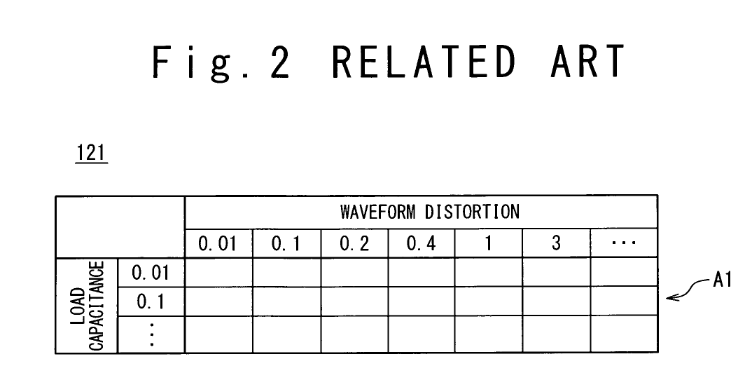

According to the present embodiment, as described above, the through-current power and the charge-discharge power are treated separately in calculating the power consumption. In the related technique shown in FIG. 1, on the other hand, the through-current power and the charge-discharge power have been treated collectively. The electric power table 121 shown in FIG. 2 is prepared, because the power consumption has been considered to be greatly and complicatedly affected by the waveform distortion and the load capacitance. However, the inventors of the present application have first found that the through-current is greatly dependent on the waveform distortion while less dependent on the load capacitance. It is therefore possible to calculate the through-current power with high accuracy without using the load capacitance as a key. The present invention is based on this knowledge.

The charge-discharge power can be obtained with high accuracy by using a computational expression. As to the calculation of the through-current power, the through-current power table 21 (look-up table) which associates the waveform distortion and the power supply voltage with the through-current power is utilized. The through-current power corresponding to a specified waveform distortion and a specified power supply voltage can be easily obtained by reference to the through-current power table. Although the through-current power table 21 does not include the load capacitance as a key, the through-current power can be calculated with high accuracy because of the above-mentioned reason. The through-current power table 21 includes the power supply voltage as a key instead of the load capacitance. Therefore, the power supply voltage dependence of the through-current power can be analyzed. In other words, the present embodiment can support the case of the variable power supply voltage. Furthermore, the through-current power table 21 uses only two parameters of the waveform distortion and the power supply voltage as keys, and it is not necessary to perform the characterization by using the load capacitance as an additional key. Therefore, the characterization TAT can be reduced. That is to say, the technique according to the present embodiment can support the case of the variable power supply voltage without increasing the characterization TAT.

It is apparent that the present embodiment is not limited to the above embodiments and may be modified and changed without departing from the scope and spirit of the invention.

What is claimed is:

1. A method of calculating power consumption of a circuit including standard cells, comprising:
performing a computer simulation of said circuit to calculate waveform distortion of an input signal with respect to each of said standard cells;
calculating through-current power corresponding to said calculated waveform distortion and a specified power supply voltage with respect to each of said standard cells,
wherein said through-current power is calculated by reference to a through-current power table that is provided with respect to each cell type,
wherein said through-current power table indicates through-current power of a standard cell with respect to each combination of plural kinds of waveform distortion of an input signal input to said standard cell and plural kinds of power supply voltage supplied to said standard cell;
calculating charge-discharge power of said circuit by using load capacitance information of said circuit and said specified power supply voltage; and
calculating power consumption of said circuit based on said calculated through-current power and said calculated charge-discharge power.

2. The method according to claim 1, further comprising generating said through-current power table with respect to each cell type that includes:
performing a computer simulation of said standard cell to calculate time variation of through-current in said standard cell corresponding to each combination of said plural kinds of waveform distortion and said plural kinds of power supply voltage;
calculating through-current power of said standard cell by using said calculated time variation of through-current and corresponding one of said plural kinds of power supply voltage; and
generating said through-current power table that indicates said calculated through-current power with respect to each combination of said plural kinds of waveform distortion and said plural kinds of power supply voltage.

3. A method of generating a through-current power table with regard to a standard cell, comprising:
performing a computer simulation of said standard cell to calculate time variation of through-current in said standard cell corresponding to each combination of plural kinds of waveform distortion of an input signal input to said standard cell and plural kinds of power supply voltage supplied to said standard cell;
calculating through-current power of said standard cell by using said calculated time variation of through-current and corresponding one of said plural kinds of power supply voltage; and
generating a through-current power table that indicates said calculated through-current power with respect to each combination of said plural kinds of waveform distortion and said plural kinds of power supply voltage.

4. A computer-readable medium on which a through-current power table with regard to a standard cell is recorded,
the through-current power table comprising:
data of plural kinds of waveform distortion of an input signal input to said standard cell;
data of plural kinds of power supply voltage supplied to said standard cell; and
data of through-current power corresponding to each combination of said plural kinds of waveform distortion and said plural kinds of power supply voltage.
